(19) United States
(12) Patent Application Publication
(10) Pub. No.: US 2025/0208929 A1
(43) Pub. Date: Jun. 26, 2025

(54) DYNAMICALLY MAPPING APPLICATION PROGRAMMING INTERFACES

(71) Applicant: TEACHERS INSURANCE AND ANNUITY ASSOCIATION OF AMERICA, New York, NY (US)

(72) Inventors: Daniel Hursh, Dayton, OH (US); Sheppard David Narkier, Charlotte, NC (US)

(21) Appl. No.: 18/392,059

(22) Filed: Dec. 21, 2023

(51) Int. Cl. G06F 9/54; G06F 8/30

(52) U.S. Cl. CPC G06F 9/541; G06F 8/30

(57) ABSTRACT

Systems and methods for dynamically mapping application programming interfaces (APIs). The system may include an API database storing API data indicating operational characteristics of one or more APIs. The system may include a mapping engine which causes the system to receive, from a user device, an API mapping request including API generation criteria. The system may generate the API mapping based upon the API generation criteria and the API data. The API mapping may include an association of at least a portion of the API generation criteria and functions of the one or more APIs satisfying the API generation criteria, an indication of a new API having new functions, an indication the APIs do not satisfy the API generation criteria, and/or an indication of the API generation criteria not satisfied by the API mapping. The system may provide the API mapping to the user device.

### FIELD OF THE INVENTION

The present disclosure generally relates to systems and methods involving application programming interfaces (APIs), and more particularly, to systems and methods for dynamically mapping application programming interfaces.

### BACKGROUND

While numerous application programming interfaces may be available within a computing ecosystem to develop new software, experiences, integrations, etc., the time and effort required to determine which available APIs may be suitable based upon their operational characteristics may be easily outweighed by the time and effort to create a new API. However, creating a new API to add to an already-extensive collection of existing APIs only exacerbates the underlying circumstance which led to the creation of the new API, and further may duplicate at least some of the operational characteristics of one or more APIs available for use.

The conventional techniques for determining which APIs from a collection of APIs may be suitable for a particular use may include additional ineffectiveness, inefficiencies, encumbrances, and/or other drawbacks.

Accordingly, there is a need for systems and methods for dynamically mapping APIs as described herein.

### SUMMARY

The present embodiments may relate to, inter alia, systems and methods for dynamically mapping APIs.

In one embodiment, a system for dynamically mapping application programming interfaces (APIs). The system may include an API database storing API data of a plurality of APIs, the API data indicating one or more operational characteristics of one or more APIs of the plurality of APIs. The system may include a mapping engine stored as a set of computer-executable instructions on one or more memories and executable by one or more processors, which may cause the system to: (i) receive, from a user device, an API mapping request including API generation criteria indicating the one or more operational characteristics of one or more mapped APIs of an API mapping; (ii) generate the API mapping, based upon the API generation criteria and the API data, wherein the API mapping includes one or more of: (a) an association of at least a portion of the API generation criteria and one or more functions of the one or more APIs satisfying the at least the portion of respective API generation criteria, the one or more functions being indicated by the API data associated with the one or more APIs; (b) an indication of a new API having one or more new functions, wherein the new API is based upon the one or more APIs, and the new API satisfies the API generation criteria not satisfied by the API mapping; (c) an indication the plurality of APIs do not satisfy the API generation criteria; or (d) an indication of the API generation criteria not satisfied by the API mapping; and (iii) provide, to the user device, the API mapping. The system may include additional, less, or alternate functionality, including that discussed elsewhere herein.

In one aspect of the system, based upon the API mapping including the indication of the new API, the system may further include stored instructions that, when executed by the one or more processors, may further cause the system to (i) receive, from the user device, a request to receive the new API; (ii) generate the new API; and (iii) provide, to the user device, the new API.

In an aspect of the system, the one or more new functions of the new API may include one or more existing functions which are reconfigured.

In another aspect of the system, the API data may include one or more of a method, a function, an endpoint, an action, a request parameter, a data format, a use case, a security characteristic, or a response.

In yet another aspect of the system, the API data may be based upon one or more of documentation of an API of the plurality of APIs, historical API mappings accepted by a user, or metadata associated with the API.

In still yet another aspect of the system, the API generation criteria may include one or more of a function, a use case, a security characteristic, or a user experience.

In another aspect of the system, to receive the API mapping request including the API generation criteria, the system may further include stored instructions that, when executed by the one or more processors, may further cause the system to: (i) receive, from the user device, a wireframe; (ii) generate one or more questions; (iii) provide, to the user device, the one or more questions; and (iv) receive, from the user device, one or more responses associated with the one or more questions.

In yet another aspect of the system, the mapping engine may be a machine learning model trained using training data including historical API data and historical API generation criteria; and trained to make associations between historical API generation criteria and one or more historical APIs which satisfy at least the portion of the historical API generation criteria.

In still yet another aspect of the system, the system may further include stored instructions that, when executed by the one or more processors, may further cause the system to: (i) retrain the machine learning model based upon an update to the training data, and store the retrained machine learning model to the one or more memories, to generate subsequent API mappings.

In another aspect of the system, the API mapping includes a metric indicating satisfaction of the API generation criteria by the one or more APIs of the API mapping.

In another embodiment, a computer-implemented method for dynamically mapping application programming interfaces (APIs). The computer-implemented method may include: (i) receiving, via one or more processors from a user device, an API mapping request including API generation criteria indicating one or more operational characteristics of one or more mapped APIs of an API mapping; (ii) obtaining, by the one or more processors, API data of a plurality of APIs, the API data indicating the one or more operational characteristics of one or more APIs of the plurality of APIs; (iii) generating, by the one or more processors, the API mapping based upon the API generation criteria and the API data, wherein the API mapping may include one or more of: (a) an association of the at least a portion of the API generation criteria and one or more functions of the one or more APIs satisfying the at least the portion of respective API generation criteria, the functions of the one or more APIs being indicated by the API data associated with the one or more APIs; (b) an indication of a new API having one or more new functions, wherein the new API is based upon the one or more APIs, and the new API satisfies the API generation criteria not satisfied by the API mapping; (c) an indication the plurality of APIs do not satisfy the API generation criteria; or (d) an indication of the API generation criteria not satisfied by the API mapping; and (iv) providing, by the one or more processors to the user device, the API mapping. The method may include additional, less, or alternate functionality or actions, including those discussed elsewhere herein.

In another aspect, a non-transitory computer-readable medium storing processor-executable instructions that, when executed by one or more processors, cause the one or more processors to: (i) receive, from a user device, an API mapping request including API generation criteria indicating one or more operational characteristics of one or more mapped APIs of an API mapping; (ii) obtain API data of a plurality of APIs, the API data indicating the one or more operational characteristics of one or more APIs of the plurality of APIs; (iii) generate the API mapping based upon the API generation criteria and the API data, wherein the API mapping includes one or more of: (a) an association of at least a portion of the API generation criteria and one or more functions of the one or more APIs satisfying the at least the portion of respective API generation criteria, the functions of the one or more APIs being indicated by the API data associated with the one or more APIs; (b) an indication of a new API having one or more new functions, wherein the new API is based upon the one or more APIs, and the new API satisfies the API generation criteria not satisfied by the API mapping; (c) an indication the plurality of APIs do not satisfy the API generation criteria; or (d) an indication of the API generation criteria not satisfied by the API mapping; and (iv) provide, to the user device, the API mapping. The instructions may direct additional, less, or alternate functionality, including that discussed elsewhere herein.

In accordance with the above, and with the disclosure herein, the present disclosure includes improvements in computer functionality or in improvements to other technologies at least because the claims recite, e.g., a mapping engine configured to generate an API mapping. The API mapping can be generated from API functions and be based upon API generation criteria and API data, where the mapping engine can determine a success state or failure state of the API mapping. In addition, the mapping engine can be applied to many multiples (e.g., hundreds or thousands) of different APIs, each with different formats, syntaxes, function parameters, function outputs, communication protocols, and/or other code, function, or other API-based differences. That is, the mapping engine can be implemented or executed to analyze various APIs to create a mapping comprising a new API, in which a new API map may define new API functions or code, and/or that may link or call existing API functions or code, in a new more efficient and/or streamlined API when compared to the previous multiple APIs. In various aspects, the new more efficient and/or streamlined API can be displayed or graphically represented as a graphical map, which may, for example, indicate the various calls or code of the API. Still further, the new more efficient and/or streamlined API may comprise a reduced set of functions and/or code when compared to the original, different APIs and/or API data from which the new API was generated. For example, in one aspect, the new, more efficient API may include a single function that replaces two or more functions in respective two or more APIs. Still further, the single function can also be formatted or refactored to accept fewer parameters and/or be accessed in a single programming language and/or protocol, which streamlines calls to the new API from other devices (e.g., other systems or a client device, such as a user device). That is, the present disclosure describes improvements in the functioning of the computer itself or “any other technology or technical field” because the code base, as used by the API, may be reduced and streamlined, which not only improves the underlying device by requiring less memory for storage of the API (compared to the original multiple APIs from which it is generated), but also improves the execution speed and/or efficiency of the new API by the underlying device. This improves over the prior art at least because system or platforms, which would otherwise be required to implement multiple, different APIs, and which would require increased memory storage and/or execution compute cycles by processing devices.

The present disclosure includes specific features other than what is well-understood, routine, conventional activity in the field, and/or otherwise adds unconventional steps that confine the disclosure to a particular useful application, e.g., systems and methods for dynamically mapping application programming interfaces based upon API generation criteria.

Additional, alternate and/or fewer actions, steps, features and/or functionality may be included in an aspect and/or embodiments, including those described elsewhere herein.

### BRIEF DESCRIPTION OF THE DRAWINGS

The figures described below depict various aspects of the applications, methods, and systems disclosed herein. It should be understood that each figure depicts one embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 depicts a block diagram of an exemplary computer environment in which methods and systems for dynamically mapping APIs are implemented, according to one embodiment.

FIG. 2 depicts a block diagram of an exemplary computing device in which computer-implemented methods and systems for dynamically mapping APIs are implemented, according to one embodiment.

FIG. 3 depicts a combined block and logic diagram for training an API mapping model to dynamically map APIs, according to one embodiment.

FIG. 4A depicts an example user interface to request an API mapping, according to one embodiment;

FIG. 4B depicts an example wireframe for providing API generation criteria, according to one embodiment;

FIG. 4C depicts a block diagram of an example API mapping, according to one embodiment; and

FIG. 5 depicts a flow diagram of an exemplary computer-implemented method systems for dynamically mapping APIs, according to one embodiment.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

### Overview

The computer systems and methods disclosed herein generally relate to, inter alia, dynamically mapping APIs. Using the disclosed techniques to dynamically map one or more existing APIs in an automated fashion based upon user-provided API operational characteristics, provides the user the ability to quickly and easily understand how one or more existing APIs may be suitable for their desired purpose when fulfilling the API operational characteristics. Moreover, dynamically mapping APIs saves the user time and effort they would otherwise expend to manually evaluate the suitability of one or more APIs and/or create a new API, which in the end, may only duplicate at least some of the functionality of existing APIs available for use.

The disclosed systems and methods provide dynamic mapping of APIs by generating an API mapping for a user. As further described below, an API database or other memory may store API data of a plurality of existing APIs. The API data may indicate operational characteristics of the plurality of existing APIs, such as methods, functions, endpoints, actions, request parameters, data formats, use cases, security characteristics, responses, and/or other suitable operational characteristics of the plurality of APIs. The API data may be based upon documentation of an API, historical API mappings, metadata associated with the API, etc.

A server may execute a mapping engine, which may be and/or include a machine learning model, to generate the API mapping, among other things. The mapping engine may obtain the API data, as well as obtain API generation criteria from a user (e.g., via a user device executing an application associated with the API mapping). The API generation criteria may indicate operational characteristics required and/or desired by the user for the APIs of the API mapping (i.e., mapped APIs), such that the API mapping may include a mapping of the API generation criteria to one or more mapped APIs of the API mapping, thereby indicating how the mapped APIs satisfy, or conversely do not satisfy, the API generation criteria. The API generation criteria may include a function, a use case, a security characteristic, a user experience, etc. The user may provide the API generation criteria via a user device, such as by uploading a wireframe indicating the API generation criteria, answering one or more questions associated with the API generation criteria, or in any other suitable manner.

The mapping engine may generate the API mapping based upon the API generation criteria and the API data. The API mapping may include various types of information informing the user how the mapped APIs satisfy the API generation criteria, for example the API mapping may include one or more metrics (e.g., a score, ranking, visual indications of metrics, etc.) indicating how (e.g., quantitatively or qualitatively) the mapped APIs satisfy the API generation criteria. The API mapping may include text, visual components, hyperlinks (e.g., to code associated with the mapped APIs), among other things. The API mapping may also include an association between at least a portion of the API generation criteria, and functions (e.g., as indicated by the API data) of the one or more mapped APIs which satisfy the API generation criteria. The API mapping may further include an indication of a new API which satisfies the API generation criteria, and further the mapping engine may be able to generate the new API. The new API may be based upon one or more of the existing APIs, but, for example, have new and/or additional functions not found in the existing APIs, such as functions of existing APIs which are reconfigured to create the new API and meet the API generation criteria. The API mapping may include an indication that none of the plurality of existing APIs satisfy the API generation criteria (e.g., such that none of the existing APIs are able to be mapped to the API generation criteria), or an indication of the API generation criteria not satisfied by the APIs which are mapped, e.g., when at least a portion of the API generation criteria is satisfied by the mapped APIs.

The mapping engine may provide the API mapping to the user via the user device, for example to be displayed on the client application associated with the mapping, displayed via a webpage of a browser executing on the user device, etc.

### Exemplary Computing Environment

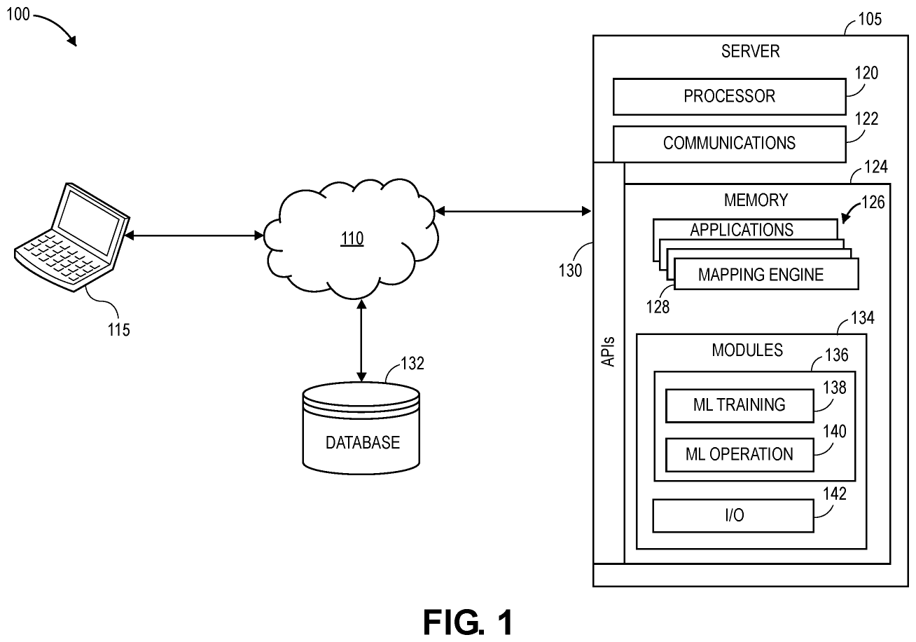

FIG. 1 depicts an exemplary computing environment 100 associated with dynamically mapping APIs. Although FIG. 1 depicts certain entities, components, equipment, and/or devices, it should be appreciated that additional or alternate entities, components, equipment, and/or devices are envisioned.

As illustrated in FIG. 1, the computing environment 100 may include, in one aspect, one or more servers 105 which may perform the at least some of the functionalities and techniques disclosed, such as dynamically mapping APIs. The servers 105 may be part of a cloud network or may otherwise communicate with other hardware or software components within one or more cloud computing environments to send, retrieve, or otherwise analyze data or information described herein. In one example, in certain aspects of the present techniques, the computing environment 100 may comprise an on-premise computing environment, a multi-cloud computing environment, a public cloud computing environment, a private cloud computing environment, and/or a hybrid cloud computing environment. In one example, an entity (e.g., a business providing APIs for its software applications) may host one or more services in a public cloud computing environment (e.g., Amazon Web Services (AWS), Google Cloud, IBM Cloud, Microsoft Azure, etc.). The public cloud computing environment may be a traditional off-premise cloud (i.e., not physically hosted at a location owned/controlled by the business). Alternatively, or in addition, aspects of the public cloud may be hosted on-premise at a location owned/controlled by the business. The public cloud may be partitioned using visualization and multi-tenancy techniques and/or may include one or more of software-as-a-service (SaaS), infrastructure-as-a-service (IaaS) and/or platform-as-a-service (PaaS).

The computing environment 100 may include a network 110 comprising any suitable network or networks, including a local area network (LAN), wide area network (WAN), Internet, or combination thereof. For example, the network 110 may include a wireless cellular service (e.g., 4G service, 5G service, 6G service, etc.). Generally, the network 110 enables bidirectional communication between the servers 105 and a user device 115. In one aspect, the network 110 may comprise a cellular base station, such as cell tower(s), communicating to the one or more components of the computing environment 100 via wired/wireless communications based upon any one or more of various mobile phone standards, including NMT, GSM, CDMA, UMTS, LTE, 5G, 6G, or the like. Additionally or alternatively, the network 110 may comprise one or more routers, wireless switches, or other such wireless connection points communicating to the components of the computing environment 100 via wireless communications based upon any one or more of various wireless standards, including by non-limiting example, IEEE 802.11a/ac/ax/b/c/g/n (Wi-Fi), Bluetooth, and/or the like.

The servers 105 may include one or more processors 120. The processors 120 may include one or more central processing units (CPUs), graphics processing units (GPUs), and/or any other suitable processor. The processors 120 may be communicatively coupled to a memory 124 via a computer bus (not depicted) to create, read, update, transmit, delete, or otherwise access or interact with the data, data packets, or otherwise electronic signals to and from the processors 120 and memory 124, e.g., in order to implement or perform the machine-readable instructions, methods, processes, elements, or limitations, as illustrated, depicted, or described for the various flowcharts, illustrations, diagrams, figures, and/or other disclosure herein. The processors 120 may interface with the memory 124 via a computer bus to execute an operating system (OS) and/or computing instructions contained therein, and/or to access other services/aspects. For example, the processors 120 may interface with the memory 124 via the computer bus to create, read, update, delete, or otherwise access or interact with the data stored in the memory 124 and/or one or more databases 132.

The servers 105 may include a communications component 122 which allows the servers 105 to communicate over the network 110 (e.g., with user device 115, databases 132) via any suitable wired and/or wireless connection, e.g., using any suitable network interface controller(s) of the communications component 122. The communications component 122 may include one or more transceivers (e.g., WWAN, WLAN, and/or WPAN transceivers) functioning in accordance with IEEE reference standards, 3GPP reference standards, and/or other reference standards that may be used in receipt and transmission of data via external/network ports of the servers 105 connected to computer network 110.

The memory 124 may include one or more memories and/or forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memory 124 may store machine-readable instructions executable by the processors 120, including any of one or more application(s) 126, one or more software component(s), and/or one or more APIs 130.

The one or more applications 126 may include an operating system (OS) (e.g., Microsoft Windows, Linux, UNIX, etc.) capable of facilitating the functionalities, applications, methods, or other software as discussed herein. In general, a computer program or computer based product, application, instructions, or code (e.g., machine learning models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 120 (e.g., working in connection with the respective operating system in memory 124) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

The software applications 126 may include a mapping engine 128. The mapping engine 128 may generate the API mapping of one or more APIs 130 which satisfy at least a portion of API generation criteria, e.g., API generation criteria the server 105 receives from the user device 115, as further described below. In at least some aspects, the mapping engine 128 may be and/or include a machine learning (ML) model. The ML model of the mapping engine 128 may be trained, also as further described below, using historical API data of historical APIs and historical API generation criteria to make associations between the historical API generation criteria, and one or more historical APIs which satisfy at least the portion of the historical API generation criteria.

The one or more APIs 130 may allow two or more software applications, software components, software services, etc., to communicate and/or interact with one another (e.g., via the communication component 122 and/or the network 110), exchange data (e.g., via API calls between the applications), or other suitable functions carried out by the APIs 130. For example, the server 105 may provide one or more APIs 130 for one or more of the software applications 126, allowing software applications executing on another device, such as the user device 115 communicatively coupled to the server 105, to interact and/or share data with the software applications 126 associate with the APIs 130.

The server 105 may include, and/or have access to (e.g., via network 110) one or more databases 132. The databases 132 may be or include a relational database, such as Oracle, DB2, MySQL, a NoSQL based database, such as MongoDB, or another suitable database. The databases 132 may store data and/or datasets, such as API code, training datasets used to train and/or operate one or more ML models, among other things. A dataset may include one or more types of data, records, files, etc., however, the term data and dataset may be used interchangeably herein.

The databases 132 may include API data of a plurality of APIs, such as the APIs 130, APIs associated with the applications 126, etc. The API data may indicate operational characteristics of the plurality of APIs 130, such as of methods, functions, endpoints, actions, request parameters, data formats, use cases, security characteristics, responses, and/or other suitable operational characteristics of the APIs 130. The API data may be based upon documentation of the associated API 130, metadata associated with the API 130, data generated from API calls to the API 130 (e.g., API calls between applications of the user device 115 and server 105), mappings generated by the mapping engine 128 (e.g., API mappings accepted, confirmed, and/or otherwise validated by a user), and/or from any other suitable source of API data.

The memory 124 may store a plurality of computing modules 134, implemented as respective sets of computer-executable instructions (e.g., one or more source code libraries, trained ML models such as neural networks, convolutional neural networks, etc.) as described herein.

In one aspect, the computing modules 134 may include an ML module 136. The ML module 136 may include ML training module (MLTM) 138 and/or ML operation module (MLOM) 140. In some embodiments, at least one of a plurality of ML methods and algorithms may be applied by the ML module 136, which may include, but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of ML, such as supervised learning, unsupervised learning, and reinforcement learning.

In one aspect, the ML based algorithms may be included as a library or package executed on server(s) 105. For example, libraries may include the TensorFlow based library, the PyTorch library, and/or the scikit-learn Python library.

In one embodiment, the ML module 136 employs supervised learning, which involves identifying patterns in existing data to make predictions about subsequently received data. Specifically, the ML module is “trained” (e.g., via MLTM 138) using training data, which includes exemplary inputs and associated exemplary outputs. Based upon the training data, the ML module 136 may generate a predictive function which maps outputs to inputs and may utilize the predictive function to generate ML outputs based upon data inputs. The exemplary inputs and exemplary outputs of the training data may include any of the data inputs or ML outputs described above. In the exemplary embodiments, a processing element may be trained by providing it with a large sample of data with known characteristics or features.

In another embodiment, the ML module 136 may employ unsupervised learning, which involves finding meaningful relationships in unorganized data. Unlike supervised learning, unsupervised learning does not involve user-initiated training based upon exemplary inputs with associated outputs. Rather, in unsupervised learning, the ML module 136 may organize unlabeled data according to a relationship determined by at least one ML method/algorithm employed by the ML module 136. Unorganized data may include any combination of data inputs and/or ML outputs as described above.

In yet another embodiment, the ML module 136 may employ reinforcement learning, which involves optimizing outputs based upon feedback from a reward signal. Specifically, the ML module 136 may receive a user-defined reward signal definition, receive a data input, utilize a decision-making model to generate the ML output based upon the data input, receive a reward signal based upon the reward signal definition and the ML output, and alter the decision-making model so as to receive a stronger reward signal for subsequently generated ML outputs. Other types of ML may also be employed, including deep or combined learning techniques.

The MLTM 138 may receive labeled data at an input layer of a model having a networked layer architecture (e.g., an artificial neural network, a convolutional neural network, etc.) for training the one or more ML models. The received data may be propagated through one or more connected deep layers of the ML model to establish weights of one or more nodes, or neurons, of the respective layers. Initially, the weights may be initialized to random values, and one or more suitable activation functions may be chosen for the training process. The present techniques may include training a respective output layer of the one or more ML models. The output layer may be trained to output a prediction, for example.

The MLOM 140 may comprising a set of computer-executable instructions implementing ML loading, configuration, initialization and/or operation functionality. The MLOM 140 may include instructions for storing trained models (e.g., in the electronic databases 132). As discussed, once trained, the one or more trained ML models may be operated in inference mode, whereupon when provided with de novo input that the model has not previously been provided, the model may output one or more predictions, classifications, etc., as described herein.

In operation, ML model training module 138 may access databases 132 or any other data source for training data suitable to generate one or more ML models. The training data may be sample data with assigned relevant and comprehensive labels (classes or tags) used to fit the parameters (weights) of an ML model with the goal of training it by example. In one aspect, once an appropriate ML model is trained and validated to provide accurate predictions and/or responses, the trained model may be loaded into MLOM 140 at runtime to process input data and generate output data.

While various embodiments, examples, and/or aspects disclosed herein may include training and generating one or more ML models for the server 105 to load at runtime, it is also contemplated that one or more appropriately trained ML models may already exist (e.g., in databases 132) such that the server 105 may load an existing trained ML model at runtime. It is further contemplated that the server 105 may retrain, fine-tune, update and/or otherwise alter an existing ML model before and/or after loading the model at runtime.

In one aspect, the computing modules 134 may include an input/output (I/O) module 142, comprising a set of computer-executable instructions implementing communication functions. The I/O module 142 may include a communication component configured to communicate (e.g., send and receive) data via one or more external/network port(s) to one or more networks or local terminals, such as the computer network 110 and/or the user device 115 described herein. In one aspect, the server 105 may include a client-server platform technology such as ASP.NET, Java J2EE, Ruby on Rails, Node.js, a web service or online API, responsive for receiving and responding to electronic requests.

I/O module 142 may further include or implement an operator interface configured to present information to an administrator or operator and/or receive inputs from the administrator and/or operator. An operator interface may provide a display screen. The I/O module 142 may facilitate I/O components (e.g., ports, capacitive or resistive touch sensitive input panels, keys, buttons, lights, LEDs), which may be directly accessible via, or attached to, servers 105 or may be indirectly accessible via or attached to the user device 115. According to one aspect, an administrator or operator may access the servers 105 via the user device 115 to review information, make changes, input training data, initiate training via the MLTM 138, and/or perform other functions (e.g., operation of one or more trained models via the MLOM 140). In some aspects, the I/O module 142 may facilitate communications between the APIs 130 of the server 105 and other devices, such as user device 115.

The one or more servers 105 may also be in communication with one or more user devices 115, e.g., a user device associated with a user requesting information/data from, and or providing information/data to, one or more applications of the server 105 such as mapping engine 128. The user device 115 may comprise one or more computers and/or multiple, redundant, or replicated client computers accessed by one or more users. The user device 115 may access services or other components of the computing environment 100 via the network 110. The user device 115 may include one or more computing devices (e.g., desktop computer, laptop computer, terminal), mobile devices, wearables, smart watches, smart contact lenses, smart glasses, AR glasses/headsets, VR glasses/headsets, mixed or extended reality glasses/headsets, voice bots or chatbots, ChatGPT bots, and/or other suitable electronic or electrical components. The user device 115 may include a memory and a processor for, respectively, storing and executing one or more modules, computer-executable instructions, etc. The memory may include one or more suitable storage media such as a magnetic storage device, a solid-state drive, random access memory (RAM), etc. The user device 115 may access services or other components of the computing environment 100 via the network 110, as further described below.

In some embodiments, the computing environment 100, e.g., via server 105, may execute the mapping engine 128 to dynamically map one or more APIs to, and/or based upon, API generation criteria of a user. For example, a user may require data from one or more APIs offered by an organization as indicated by API generation criteria, however, the number of APIs offered by the organization may be very extensive such that the user is not aware of all of the operational characteristics (e.g., functions, use cases, etc.) of all the organization's APIs at their disposal. Rather than generate one or more new APIs from scratch to access the organizations data which satisfy their API generation criteria, the user may request an API mapping via the mapping engine 128 to inform them of one or more existing APIs of the organization which may satisfy the API generation criteria.

In one example, the user may provide the API request to the mapping engine 128 via a user device such as user device 115 may execute a client application associated with the mapping engine 128, such as a mobile application (“app”) in communication with the mapping engine 128 via network 110. The mobile app may allow the user to request the API mapping by upload a wireframe indicating the API generation criteria. In one example, the user may access a website associated with generating the API mapping, such as a website hosted by server 105 executing mapping engine 128. The website may include a graphical user interface (GUI) resembling a search engine which the user accesses to search for APIs fulfilling their API generation criteria. The website may include one or more questions for the user, wherein the answers indicate the API generation criteria. In another example, the client app and/or website may include a form for the user to fill out which provides the API generation criteria. In one example, a user may have requested an API mapping in the past with their API generation criteria being stored in memory, such as databases 132, and may request another API mapping to see if additional APIs 130 may now be available to satisfy the API generation criteria. While several examples are described, these are for case of illustration and the disclosed techniques may include obtaining the API generation criteria in any suitable manner.

To generate the API mapping, the mapping engine 128 may obtain and/or access (e.g., from memory 124 and/or databases 132) API data indicating operational characteristics of a plurality of APIs 130, such as APIs offered by the organization. The mapping engine 128 may associate the API data with the API generation criteria to map the one or more APIs 130. This may include the mapping engine 128 using the API generation criteria to determine whether one or more of the APIs 130 satisfy at least a portion of the API generation criteria, which may include the API mapping indicating the API generation criteria satisfied and not satisfied by the mapping. The mapping engine 128 may use the API generation criteria to determine whether one or more existing APIs 130 may be reconfigured and/or expanded by the server 105 to generate a new API 130 which satisfies at least a portion of the API generation criteria, or whether none of the APIs 130 satisfy the API criteria, among other things.

In at least some aspects, the API mapping may include an association of at least a portion of the API generation criteria, and functions of one or more APIs 130 (e.g., as indicated by associated API data) which satisfy at least the portion of respective API generation criteria. For example, the user may provide API generation criteria indicating an API which provides both historical weather information and a weather forecast over the next week for the same location based upon the user providing a location and a past date as inputs. The mapping engine 128 may determine two existing APIs 130 satisfy the API generation criteria, a first API which provides a weekly weather forecast based upon the user providing a location, and a second API which provides historical weather information based upon a user providing a location and date. The API mapping may indicate all of this information, and further allow the user to access the code of the first and second APIs.

In at least some aspects, the mapping engine 128 may generate an API mapping which includes altering, reconfiguring, and/or expanding the function(s), service(s) and/or other functionality of one or more existing APIs 130 to generate a new API. The new API may satisfy API generation criteria otherwise unsatisfied by the one or more existing APIs 130. The API mapping may indicate the one or more new functions of the new API 130 which satisfy API generation, and further what exactly those functions would look like (e.g., parameters, etc.). In one example, the mapping engine 128 may expand the functionality of an API 130 by configuring the API 130 to accept additional parameters using an existing function and/or service. In one example, the mapping engine 128 may reconfigure an API 130 to call existing functions and/or services in a specific order. In one example, the mapping engine 128 may generate an API which is a wrapper of multiple existing APIs. Using the previous example of an API to provide historical and present weather data, the mapping engine 128 may generate a new API which includes the functionality of both the first and second APIs, and allow the user to request and obtain the new API (e.g., via downloading the code of the new API). In any one of these examples, the API mapping may indicate the new, expanded, reconfigured, etc., functions/services/functionality of the new API 130.

In at least some aspects, the API mapping may indicate any API generation criteria which is not satisfied by the API mapping. For example, the API generation criteria may include five criteria (e.g., three functions, one use case, and one security characteristic), only three of which (e.g., one function, the use case and the security characteristic) are satisfied by existing APIs 130. Accordingly, the API mapping may indicate which three criteria (e.g., the one function, the use case and the security characteristic) are satisfied by corresponding APIs 130 and how they are satisfied, e.g., by indicating in the mapping which APIs 130 satisfy each and/or the criteria, what the functions of the APIs 130 are associated with the API generation criteria, what the existing uses cases of the APIs 130 use are, the security characteristics of the APIs 130, and/or any other suitable information indicating how the APIs 130 satisfy the API generation criteria. The API mapping may indicate the two criteria which are not satisfied by any APIs 130, e.g., which API generation criteria are not satisfied. The API mapping may indicate whether generating a new API may satisfy the two unsatisfied criteria, e.g., by indicating the new functions of the new API which would satisfy the unsatisfied criteria, the parameters of the new functions, etc. In at least some aspects, the API mapping may indicate that none the exiting APIs 130 satisfy any of the API generation criteria, and as a result no associations between the APIs 130 and the API generation criteria may be indicated by the API mapping. In such an example, the mapping engine 128 may provide an indication via the API mapping that generating one or more new APIs 130 may satisfy at least some of the API generation criteria, and further may generate the APIs and allow the user to down the code for the new API.

In some aspects, if the user approves, validates, accepts and/or otherwise acknowledges the API mapping as valid (e.g., via a user interface of the user device 115 executing the associated mobile app), and the API mapping suggests generating one or more new APIs 130, only then may the mapping engine 128 may generate the new API(s). Once the mapping engine generates a new API, its associated API data may be stored (e.g., in databases 132) and the new API may be added to the plurality of the one or more APIs 130 available for future API mappings.

Although the computing environment 100 is shown to include one user device 115, one server 105, and one network 110, it should be understood that different numbers of user devices 115, networks 110, and/or servers 105 may be utilized. In one example, the computing environment 100 may include a plurality of servers 105 and/or hundreds or thousands of user devices 115, all of which may be interconnected via the network 110.

The computing environment 100 may include additional, fewer, and/or alternate components, and may be configured to perform additional, fewer, or alternate actions, including components/actions described herein. Although the computing environment 100 is shown in FIG. 1 as including one instance of various components such as server 105, network 110, user device 115, etc., various aspects include the computing environment 100 implementing any suitable number of any of the components shown in FIG. 1 and/or omitting any suitable ones of the components shown in FIG. 1. For instance, information described as being stored at databases 132 may be stored at memory 124, and therefore databases 132 may be omitted. Moreover, various aspects include the computing environment 100 including any suitable additional component(s) not shown in FIG. 1, such as but not limited to the exemplary components described above. Furthermore, it should be appreciated that additional and/or alternative connections between components shown in FIG. 1 may be implemented. As just one example, server 105 and database 132 may be connected via a direct communication link (not shown in FIG. 1) instead of, or in addition to, via network 110.

### Exemplary User Device

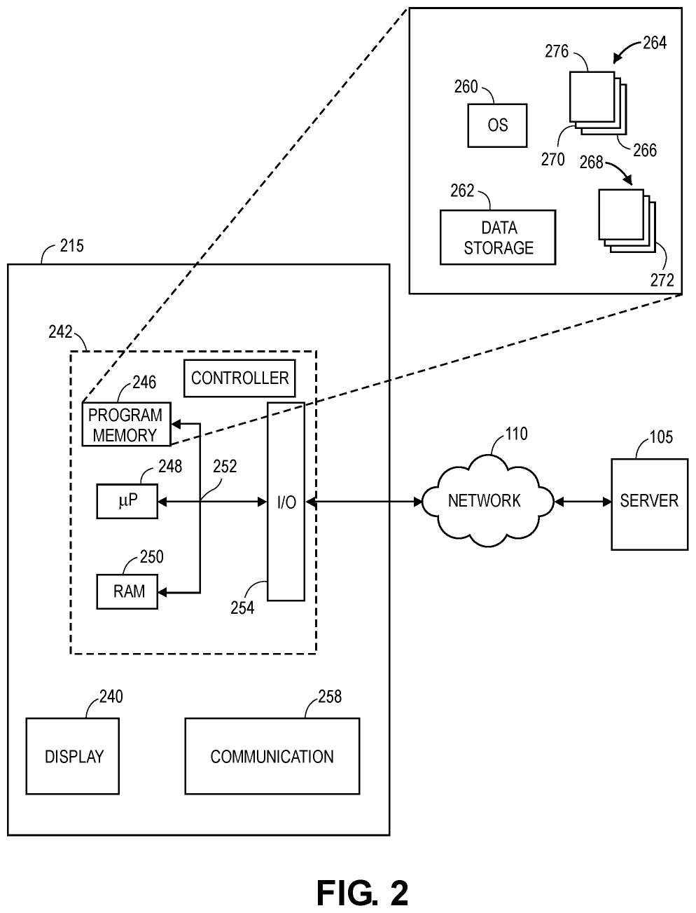

FIG. 2 depicts an exemplary user device 215, such as the user device 115. The user device 215 may include a display 240, a communication component 258, a user-input device (not shown), and a controller 242. The controller 242 may include a program memory 246, a microcontroller/processor/microprocessor (μP) 248 such as the processor 120, a random-access memory (RAM) 250, and/or an input/output (I/O) circuit 254, all of which may be interconnected via an address/data bus 252. The program memory 246 may include an operating system 260, a data storage 262, a plurality of software applications 264, and/or a plurality of software routines 268. The operating system 260, for example, may include one of a plurality of mobile platforms such as the iOS®, or Android™, developed by Apple Inc. and Google Inc., respectively.

The data storage 262 may include data such as application data for the plurality of applications 264, routine data for the plurality of routines 268, and/or other data necessary to interact with the one or more servers 105 through the network 110. In some embodiments, the controller 242 may also include, or otherwise be communicatively connected to, other data storage mechanisms (e.g., one or more hard disk drives, optical storage drives, solid state storage devices, etc.) that reside within the user device 215.

The communication component 258 may communicate with the one or more components or devices, such as server 105, via any suitable wireless communication protocol network, such as a wireless telephony network (e.g., GSM, CDMA, LTE, 5G, 6G, ultrawideband, etc.), a Wi-Fi network (e.g., having 802.11 standards), a WiMAX network, a Bluetooth network, etc. The user-input device (not shown) may include a “soft” keyboard that is displayed on the display 240 of the user device 215, an external hardware keyboard communicating via a wired and/or a wireless connection (e.g., a Bluetooth keyboard), an external mouse, a touchscreen, a stylus, and/or any other suitable user-input device.

The one or more processors 248 may be adapted and/or configured to execute any one or more of the plurality of software applications 264 and/or any one or more of the plurality of software routines 268 residing in the program memory 242, in addition to other software applications.

One of the plurality of applications 264 may be a native application and/or web browser 270, such as Apple's Safari®, Google Chrome™ mobile web browser, Microsoft Internet Explorer® for Mobile, Opera Mobile™, that may be implemented as a series of machine-readable instructions for receiving, interpreting, and/or displaying application screens or web page information from the one or more servers 105 while also receiving inputs from the user. Another application of the plurality of applications may include an embedded web browser 276 that may be implemented as a series of machine-readable instructions for receiving, interpreting, and/or displaying web page information.

One of the plurality of applications 264 may be an API mapping client application 266 for performing the various tasks and/or functions associated with the API mapping and/or mapping engine 128, such as displaying a user interface (UI) the mapping engine 128 generates, providing the API generation criteria to the mapping engine 128 (e.g., via the UI) and requesting the API mapping based upon the API generation criteria, receiving the API mapping and/or code for one or more APIs, displaying information on, and/or transmitting information from, the user device 215 to the mapping engine 128 and/or server 105, etc. Additionally, the user may also launch or instantiate any other suitable user interface application (e.g., the native application or web browser 270, and/or any other one of the plurality of software applications 264) to access the one or more servers 105 and/or mapping engine 128 to realize aspects of the inventive system.

The user device 215 may include additional, fewer, and/or alternate components, and may be configured to perform additional, fewer, or alternate actions, including components/actions described herein. Although the user device 215 is shown in FIG. 2 as including one instance of various components such as display 240, processor 248, etc., various aspects include the user device 215 implementing any suitable number of any of the components shown in FIG. 2 and/or omitting any suitable ones of the components shown in FIG. 2. Moreover, various aspects include the user device 215 including any suitable additional component(s) not shown in FIG. 2, such as but not limited to the exemplary components described above. Furthermore, it should be appreciated that additional and/or alternative connections between components shown in FIG. 2 may be implemented.

### API Mapping Model Training

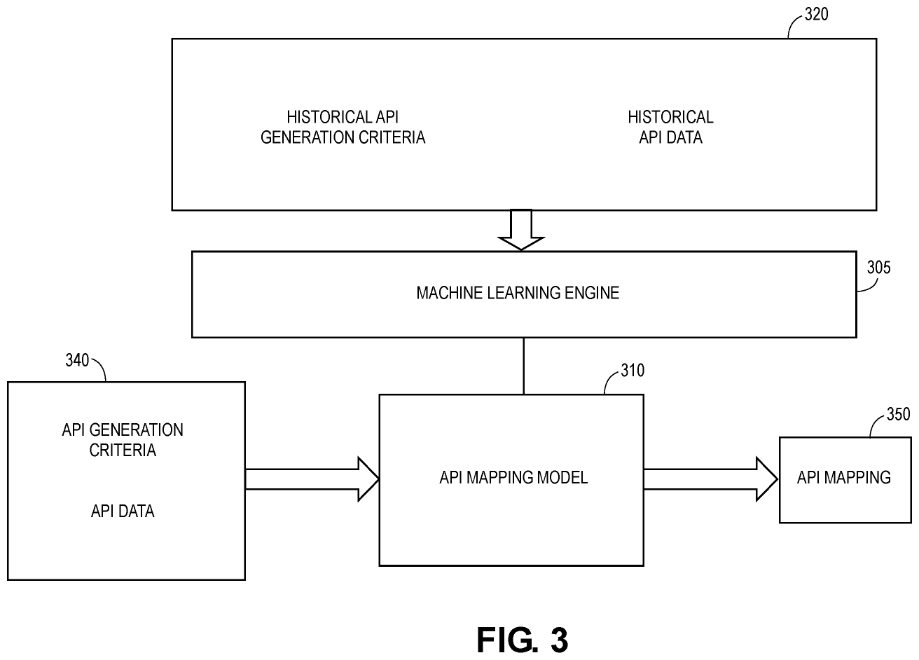

FIG. 3 schematically illustrates how an ML API mapping model 310 of a mapping engine, such as mapping engine 128, may be trained to generate the API mapping. Some of the blocks in FIG. 3 represent hardware and/or software components (e.g., block 305), other blocks represent data structures or memory storing these data structures, registers, or state variables (e.g., block 320), and other blocks represent output data (e.g., block 350). Input signals are represented by arrows labeled with corresponding signal names.

The ML engine 305 may include one or more hardware and/or software components (e.g., the ML module 136, the MLTM 138 and/or the MLOM 140) to obtain, create, (re) train, operate, fine-tune, and/or store one or more ML models, such as the API mapping model 310. To train the API mapping model 310, the ML engine 305 may use a training dataset 320. A server such as server 105 may obtain and/or have available one or more types of training data comprising a training dataset 320 (e.g., training data stored on databases 132). In one aspect, at least some of the training data 320 may be labeled to aid in (re) training and/or fine-tuning the API mapping model 310.

In one aspect, for example to train the API mapping model 310 to generate an API mapping, the training dataset 320 may include historical API data associated with a plurality of historical APIs. The historical API data may indicate methods, functions, endpoints, actions, request parameters, data formats, use cases, security characteristics, responses, and/or other operational characteristics of historical APIs.

The training dataset 320 may include historical API generation criteria. The historical API generation criteria may indicate functions, use cases, security characteristics, user experiences of historical APIs, historical API mappings and/or historical API mapping requests. The training dataset 320 may include any other suitable data to generate an API mapping.

The API mapping model 310 may be configured to process the training dataset 320 to learn associations and relationships in the training data 320, e.g., relationships between historical API generation criteria and the historical API data of historical APIs which satisfy at least the portion of the historical API generation criteria.

In one aspect, the server and/or ML engine 305 may continuously update the training dataset 320, e.g., to include new data associated with API mappings. For example, when a trained API mapping model 310 generates an API mapping which is accepted by the user and/or generates a new API, various types of data may be associated with the API mapping and/or new

API which the ML engine 305 may store as updated training data 320. This may include the API generation criteria of the API mapping, the API mapping itself, and/or the API data of the new API. Subsequently, the API mapping model 310 may be retrained based upon the updated training dataset 320, which may further cause the API mappings of the retrained API mapping model 310 may improve over time.

In one aspect, the ML engine 305 may process and/or analyze the training dataset 320 (e.g., via MLTM 138) to train the API mapping model 310 to generate the API mapping. The API mapping model 310 may be trained via regression, k-nearest neighbor, support vector regression, and/or random forest algorithms and/or models, although any type of applicable ML algorithm and/or model may be used, including training using one or more of supervised learning, unsupervised learning, semi-supervised learning, and/or reinforcement learning.

Once trained, the API mapping model 310 may perform operations on one or more data inputs 340 to produce a desired data output 350. In one aspect, the API mapping model 310 may be loaded at runtime from a database (e.g., by ML engine 305 from the databases 132) to process the input data 340. The server, mapping engine, and/or ML engine 305 may obtain the input data 340 (e.g., from the databases 132), and provide the input data 340 to the trained API mapping model 310 as an input for the API mapping model 310 to generate the API mapping as an output 350. For example, to generate API mapping as an output 350, the input data 340 may include the API generation criteria and API data previously described. The trained API mapping model 310 may make associations between the API generation criteria and API data, as previously described, to generate the API mapping as the output 350.

Returning to the example of the weather APIs, the training data 320 to train the API mapping model 310 may include historical API data of historical weather APIs. The historical API data may indicate operational characteristics of the historical weather APIs, such as historical request parameters including a location, a past date, a number of days of a forecast, etc., and may further indicate historical responses including providing historical weather data associated with the location and date, and a weather forecast for a span of time associated with the location. The training data 320 may further include historical API generation criteria including historical use cases indicating a weather forecast, and historical functions indicating future and past weather forecasts. The API mapping model 310 may be trained by the ML engine 305 to learn associations between the historical API data and historical API generation criteria regarding which historical weather APIs satisfied which historical API generation criteria. The trained API mapping model 310 may then be able to receive as an input 340 API generation criteria indicating an API which provides both historical weather information and a weather forecast over the next week for the same location based upon the user providing a location and a past date as inputs. Further based upon an input 340 of API data of APIs which include two existing weather APIs described above, the API mapping model 310 determines the two existing weather APIs satisfy the API generation criteria, and generates the API mapping indicating this information as an output 350.

### Exemplary API Mapping

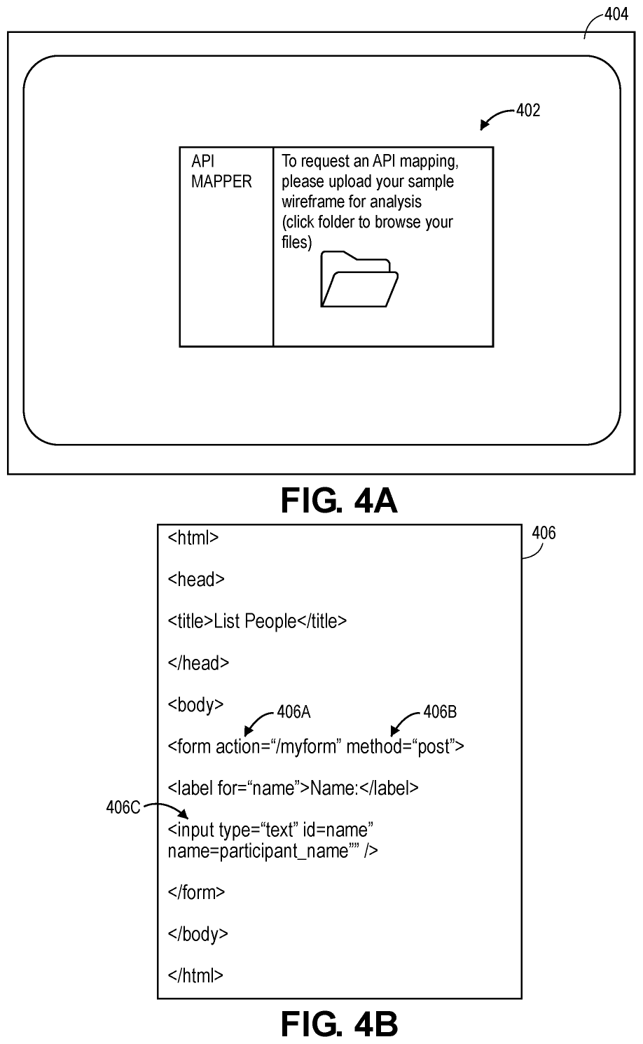

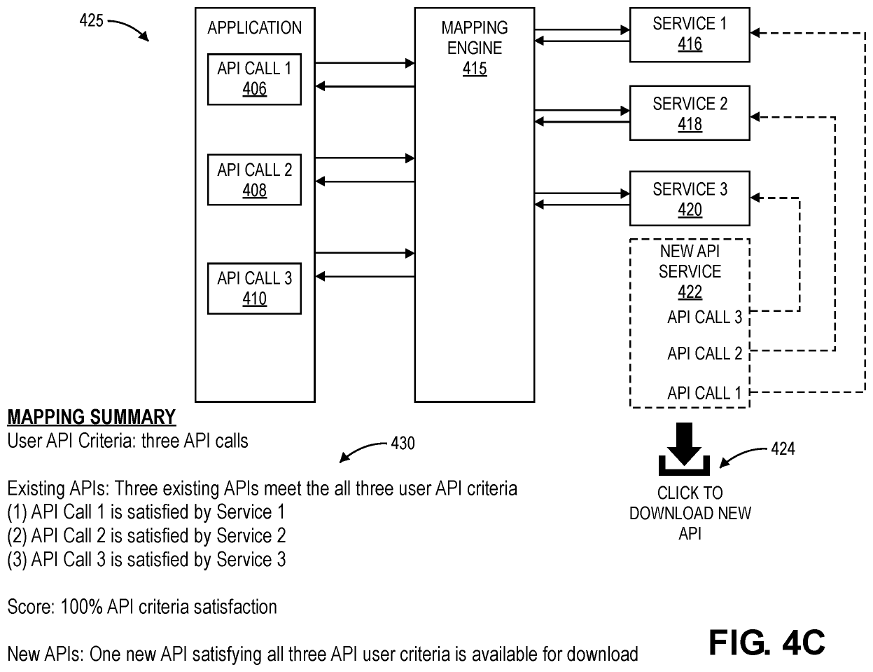

FIGS. 4A, 4B, and 4C illustrate an example UI to request an API mapping, an example wireframe for providing API generation criteria, and an example API mapping, respectively. Although FIGS. 4A-C depict certain UIs, wireframes, API mappings, components, equipment, and/or devices, it should be appreciated that these are for ease of illustration only, and additional or alternate UIs, wireframes, API mappings, components, equipment, and/or devices are envisioned.

In some embodiments, the mapping engine (e.g., mapping engine 128, API mapping model 310) may generate a UI, for example to allow the user to request an API mapping; provide API generation criteria to the mapping engine; view the API mapping; request, view and/or download code associated with a new API the mapping engine generates, etc. A user device such as user devices 115, 215 operably connected to the mapping engine may display the UI, such as user device 215 displaying the UI on display 240 via API mapping client application 266.

In the illustrated in the example UI 402 of FIG. 4A, the mapping engine generates the UI 402 which a user device displays on a screen 404 of a laptop executing an API mapping client application, such as display 240 of user device 215 executing API mapping client application 266. The UI 402 allows the user to upload a sample wireframe to the mapping engine for analysis, e.g., to determine the API generation criteria of the wireframe. By uploading the sample wireframe, the user requests an API mapping based up the API generation criteria associated with the wireframe.

Turning to the example wireframe 406 of FIG. 4B which the user may upload using the UI 402, the wireframe 406 may be and/or include a data file (e.g., stored on the memory of the laptop, such as data storage 262) including hypertext markup language (HTML) code indicating aspects of a proposed API, such as an action 406A, a method 406B, and an input 406C of the proposed API, which indicate at least some of the API generation criteria of the proposed API. Once the user uploads the wireframe 406 via the UI 402 to the mapping engine, the mapping engine may analyze the wireframe 406 to determine the API generation criteria 406A, 406B, 406C of the proposed API of the user. Although FIGS. 4A and 4B illustrate uploading the wireframe 406 via the UI 402 to the mapping engine to obtain the API generation criteria of the proposed API of the user, the mapping engine may obtain the API generation criteria in other ways as previously discussed (e.g., via one or more questions which the user answers, the user filling out a form associated with the API generation criteria, or in any other suitable manner).

Once the mapping engine obtains the API generation criteria, it may provide the API mapping based upon the API generation criteria and API data of one or more existing APIs, such as API data of APIs 130 stored in database 132 which is communicatively coupled to the mapping engine 128 via network 110. The mapping engine may determine, based upon the API data, whether one or more existing APIs associated with the API data satisfy at least a portion of the API generation criteria. This may include the mapping engine determining whether the operational characteristics of one or more existing APIs as indicated by the respective API data, correlate to the API generation criteria. In one example, the mapping engine may determine that the API generation criteria of the proposed API indicates a use case which is similar to the use case of an existing API, enrolling new members in an organization, and thus generate an API mapping which maps to the API of the similar use case in the API mapping. In one example, the mapping engine may determine that two existing APIs in combination satisfy most of the functions, inputs and outputs of the API generation criteria of the proposed API, such as a payment API for verifying credit card information using a card number, expiration date, and billing address as inputs and payment transaction information as an output. Further, the mapping engine may generate a new API based upon the two existing APIs and which satisfies all the API generation criteria of the proposed API, all of which may be indicated in the API mapping.

As illustrated by the example API mapping 405 of FIG. 4C, the API generation criteria of the proposed API of a user application includes three API calls: (1) API Call 1 406; (2) API Call 2 408; and (3) API call 3 410, which the user provides to the mapping engine 415 in any manner previously described. Based upon the API data associated with exiting APIs (e.g., APIs 130), the mapping engine 415 (e.g., ML API mapping model 310) determines three existing APIs fulfill the API generation criteria: (1) API Call 1 406 is satisfied by Service 1 416; (2) API Call 2 408 is satisfied by Service 2 418; and (3) API Call 3 410 is satisfied by Service 3 420, which the API mapping indicates visually with a block diagram 425 and with text via the mapping summary 430, any of which may be displayed for the user on their user device, such as via a UI on display 240 of user device 215 executing API mapping client application 266. The API mapping 405 further indicates that it may generate a single new API 422 which satisfies all three API generation criteria 406, 408, 410, which the user may download via download icon 424. For example, when the user clicks on the download icon 424 via the UI of a user device executing an API mapping client application, the mapping engine 415 may receive a request for the user to receive the new API, at which point the mapping engine 415 may generate the code for the user to download. The mapping summary 430 indicates the API generation criteria 406, 408, 410, how each API generation criteria 406, 408, 410 is satisfied by the existing APIs 416, 418, 420, a score indicating the metric associated with the API generation criteria satisfaction (i.e., 100% as all API generation criteria 406, 408, 410 are satisfied by either the existing APIs 416, 418, 420, or the new API 422), as well as an indication that a new API 422 which satisfies all the API generation criteria 406, 408, 410 is available to the user for download. The API mapping 425 provides the user a comprehensive mapping of mapped APIs 416, 418, 420, 422 to the API generation criteria 406, 408, 410 in an automated fashion via the mapping engine 415 without the user having to manually evaluate one or more available APIs at their disposal, saving time and effort.

### Exemplary Method for Dynamically Mapping APIs

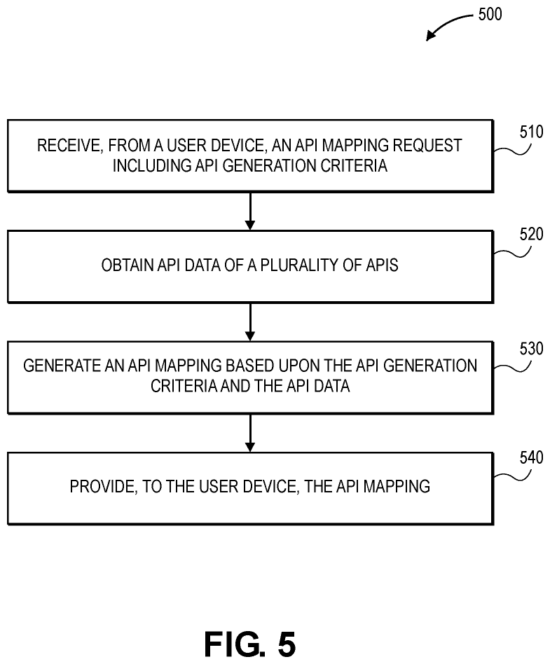

FIG. 5 depicts a flow diagram of an exemplary computer-implemented method 500 for dynamically mapping APIs, according to one embodiment. One or more steps of the method 500 may be implemented as a set of instructions stored on a computer-readable memory and executable on one or more processors. The method 500 of FIG. 5 may be implemented via one or more local or remote processors such as processor 120, servers such as server 105, user devices such as user devices 115, 215, mapping engines such as mapping engines 128, 310, 415, and/or other electronic or electrical components, which may be in wired or wireless communication with one another.

The computer-implemented method 500 may include receiving, via one or more processors from a user device, an API mapping request including API generation criteria (block 510). The API generation criteria may indicate operational characteristics of one or more mapped APIs of the API mapping, such as a function, a use case, a security characteristic, a user experience, etc. In at least some aspects, receiving the API mapping request including the API generation criteria may further include (i) receiving, by the one or more processors from the user device, a wireframe; (ii) generating, by the one or more processors, one or more questions; (iii) providing, by the one or more processors to the user device, the one or more questions; and (iv) receiving, by the one or more processors from the user device, one or more responses associated with the one or more questions.

The computer-implemented method 500 may include obtaining, by the one or more processors, API data of a plurality of APIs, the API data indicating the one or more operational characteristics of one or more APIs of the plurality of APIs (block 520). The API data may include one or more of a method, a function, an endpoint, an action, a request parameter, a data format, a use case, a security characteristic, or a response. The API data may be based upon one or more of documentation of an API of the plurality of APIs, historical API mappings accepted by a user, and/or metadata associated with the API.

The computer-implemented method 500 may include generating, by the one or more processors, the API mapping based upon the API generation criteria and the API data (block 530). The API mapping may include one or more of: (i) an association of the at least a portion of the API generation criteria and one or more functions of the one or more APIs satisfying the at least the portion of respective API generation criteria, the functions of the one or more APIs being indicated by the API data associated with the one or more APIs; (ii) an indication of a new API having one or more new functions, wherein the new API is based upon the one or more APIs, and the new API satisfies the API generation criteria not satisfied by the API mapping; (iii) an indication the plurality of APIs do not satisfy the API generation criteria; or (iv) an indication of the API generation criteria not satisfied by the API mapping. In at least some aspects, the API mapping may include a metric indicating satisfaction of the API generation criteria by the one or more APIs of the API mapping.

The computer-implemented method 500 may include providing, by the one or more processors to the user device, the API mapping (block 540).

In at least some embodiments of the computer-implemented method 500, based upon the API mapping including the indication of the new API, the method 500 may further include (i) receiving, by the one or more processors from the user device, a request to receive the new API; (ii) generating, by the one or more processors, the new API; and (iii) providing, by the one or more processors to the user device, the new API. In at least some aspects, the one or more new functions of the new API include one or more existing functions which are reconfigured.

In at least some embodiments, the computer-implemented method 500 may include a machine learning model trained (i) using training data including historical API data and historical API generation criteria; (ii) to make associations between historical API generation criteria and one or more historical APIs which satisfy at least the portion of the historical API generation criteria; and (iii) to generate the API mapping. In at least some aspects, the computer-implemented method 500 may include retraining, by the one or more processors, the machine learning model based upon an update to the training data, and storing, by the one or more processors, the retrained machine learning model to one or more memories to generate subsequent API mappings.

It should be understood that not all blocks of the exemplary flow diagram 500 are required to be performed.

### Additional Considerations

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some exemplary embodiments, the processor or processors may be located in a single location (e.g., within a home environment, an office environment or as a server farm), while in other embodiments the processors may be distributed across a number of geographic locations.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

What is claimed:

1. A system for dynamically mapping application programming interfaces (APIs), the system comprising:
an API database storing API data of a plurality of APIs, the API data indicating one or more operational characteristics of one or more APIs of the plurality of APIs;
a mapping engine stored as a set of computer-executable instructions on one or more memories and executable by one or more processors to cause the system to:
receive, from a user device, an API mapping request including API generation criteria indicating the one or more operational characteristics of one or more mapped APIs of an API mapping;
generate the API mapping, based upon the API generation criteria and the API data, wherein the API mapping includes one or more of:
an association of at least a portion of the API generation criteria and one or more functions of the one or more APIs satisfying the at least the portion of respective API generation criteria, the one or more functions being indicated by the API data associated with the one or more APIs;
an indication of a new API having one or more new functions, wherein the new API is based upon the one or more APIs, and the new API satisfies the API generation criteria not satisfied by the API mapping;
an indication the plurality of APIs do not satisfy the API generation criteria; or
an indication of the API generation criteria not satisfied by the API mapping;
and
provide, to the user device, the API mapping.

2. The system of claim 1, wherein, based upon the API mapping including the indication of the new API, the system further comprising stored instructions that, when executed by the one or more processors, further cause the system to:
receive, from the user device, a request to receive the new API;
generate the new API; and
provide, to the user device, the new API.

3. The system of claim 2, wherein the one or more new functions of the new API include one or more existing functions which are reconfigured.

4. The system of claim 1, wherein the API data includes one or more of a method, a function, an endpoint, an action, a request parameter, a data format, a use case, a security characteristic, or a response.

5. The system of claim 1, wherein the API data is based upon one or more of:
documentation of an API of the plurality of APIs;
historical API mappings accepted by a user; or
metadata associated with the API.

6. The system of claim 1, wherein the API generation criteria includes one or more of a function, a use case, a security characteristic, or a user experience.

7. The system of claim 1, wherein to receive the API mapping request including the API generation criteria, the system further comprising stored instructions that, when executed by the one or more processors, further cause the system to:
receive, from the user device, a wireframe;
generate one or more questions;
provide, to the user device, the one or more questions; and
receive, from the user device, one or more responses associated with the one or more questions.

8. The system of claim 1, wherein the mapping engine is a machine learning model trained:
using training data including historical API data and historical API generation criteria; and
to make associations between historical API generation criteria and one or more historical APIs which satisfy at least the portion of the historical API generation criteria.

9. The system of claim 8, further comprising stored instructions that, when executed by the one or more processors, further cause the system to:
retrain the machine learning model based upon an update to the training data; and
store the retrained machine learning model to the one or more memories, to generate subsequent API mappings.

10. The system of claim 1, wherein the API mapping includes a metric indicating satisfaction of the API generation criteria by the one or more APIs of the API mapping.

11. A computer-implemented method for dynamically mapping application programming interfaces (APIs), the method comprising:
receiving, via one or more processors from a user device, an API mapping request including API generation criteria indicating one or more operational characteristics of one or more mapped APIs of an API mapping;
obtaining, by the one or more processors, API data of a plurality of APIs, the API data indicating the one or more operational characteristics of one or more APIs of the plurality of APIs;
generating, by the one or more processors, the API mapping based upon the API generation criteria, the API data, and one or more of:
an association of the at least a portion of the API generation criteria and one or more functions of the one or more APIs satisfying the at least the portion of respective API generation criteria, the functions of the one or more APIs being indicated by the API data associated with the one or more APIs;
an indication of a new API having one or more new functions, wherein the new API is based upon the one or more APIs, and the new API satisfies the API generation criteria not satisfied by the API mapping;
an indication the plurality of APIs do not satisfy the API generation criteria; or
an indication of the API generation criteria not satisfied by the API mapping; and
providing, by the one or more processors to the user device, the API mapping.

12. The computer-implemented method of claim 11, wherein, based upon the API mapping including the indication of the new API, the method further comprises:
receiving, by the one or more processors from the user device, a request to receive the new API;
generating, by the one or more processors, the new API; and
providing, by the one or more processors to the user device, the new API.

13. The computer-implemented method of claim 12, wherein the one or more new functions of the new API include one or more existing functions which are reconfigured.

14. The computer-implemented method of claim 11, wherein the API data includes one or more of a method, a function, an endpoint, an action, a request parameter, a data format, a use case, a security characteristic, or a response.

15. The computer-implemented method of claim 11, wherein the API data is based upon one or more of:
documentation of an API of the plurality of APIs;
historical API mappings accepted by a user; or
metadata associated with the API.

16. The computer-implemented method of claim 11, wherein the API generation criteria includes one or more of a function, a use case, a security characteristic, or a user experience.

17. The computer-implemented method of claim 11, wherein receiving the API mapping request including the API generation criteria, further comprises:
receiving, by the one or more processors from the user device, a wireframe;
generating, by the one or more processors, one or more questions;
providing, by the one or more processors to the user device, the one or more questions; and
receiving, by the one or more processors from the user device, one or more responses associated with the one or more questions.

18. The computer-implemented method of claim 11, further comprising a machine learning model trained:
using training data including historical API data and historical API generation criteria;
to make associations between historical API generation criteria and one or more historical APIs which satisfy at least the portion of the historical API generation criteria; and
to generate the API mapping.

19. The computer-implemented method of claim 18, further comprising:
retraining, by the one or more processors, the machine learning model based upon an update to the training data; and
storing, by the one or more processors, the retrained machine learning model to one or more memories to generate subsequent API mappings.

20. A non-transitory computer-readable medium storing processor-executable instructions that, when executed by one or more processors, cause the one or more processors to at least:
receive, from a user device, an API mapping request including API generation criteria indicating one or more operational characteristics of one or more mapped APIs of an API mapping;
obtain API data of a plurality of APIs, the API data indicating the one or more operational characteristics of one or more APIs of the plurality of APIs;
generate the API mapping based upon the API generation criteria and the API data, wherein the API mapping includes one or more of:
an association of at least a portion of the API generation criteria and functions of the one or more APIs satisfying the at least the portion of respective API generation criteria, the functions of the one or more APIs being indicated by the API data associated with the one or more APIs;
an indication of a new API having one or more new functions, wherein the new API is based upon the one or more APIs, and the new API satisfies the API generation criteria not satisfied by the API mapping;
an indication the plurality of APIs do not satisfy the API generation criteria; or an indication of the API generation criteria not satisfied by the API mapping; and
provide, to the user device, the API mapping.
